(19) United States
(12) Patent Application Publication
(10) Pub. No.: US 2015/0087174 A1
(43) Pub. Date: Mar. 26, 2015

(54) MOUNTABLE CONNECTOR BOX FOR ELECTRICAL DEVICE

(71) Applicants: Robert Schmitt, Nottingham, NH (US); Anil Jeswani, Beverly, MA (US); Zhiming Huang, Taoyuan City (CN)

(72) Inventors: Robert Schmitt, Nottingham, NH (US); Anil Jeswani, Beverly, MA (US); Zhiming Huang, Taoyuan City (CN)

(73) Assignee: OSRAM SYLVANIA INC., Danvers, MA (US)

(21) Appl. No.: 14/318,792

(22) Filed: Jun. 30, 2014

Related U.S. Application Data
(60) Provisional application No. 61/882,585, filed on Sep. 25, 2013.

(51) Int. Cl. F21V 23/06; H01R 43/20; H02G 3/16; F21V 17/16

(52) U.S. Cl. CPC F21V 23/06; F21V 17/162; H01R 43/20; H02G 3/16
USPC 439/232; 29/876

(57) ABSTRACT

An electrical connector box, capable of mounting a type of electrical device to a surface, including methods of so mounting, is provided. The box includes a housing configured with a hollow to receive electronics of a device. The housing includes a first set of two or more anchor point locations and a second set of two or more anchor point locations. The box also includes a first spring clip, fastened to one of the first set of two or more anchor point locations, and a second spring clip, fastened to one of the second set of two or more anchor point locations. The spring clips are each capable of moving between a compressed position and a deployed position. The anchor point locations to which the first spring clip and the second spring clip are anchored are changeable to accommodate various electrical devices, including lighting devices such as luminaires.

### CROSS-REFERENCE TO RELATED APPLICATION

The present application claims priority of U.S. Provisional Application No. 61/882,585, filed Sep. 25, 2013 and entitled “MOUNTABLE CONNECTOR BOX FOR ELECTRICAL APPLICATIONS”, the entire contents of which are hereby incorporated by reference.

### TECHNICAL FIELD

The present invention relates to electrical devices, and more specifically, to electrical connector boxes are mountable into surfaces and suitable for various applications, including but not limited to lighting.

### BACKGROUND

Electrical junction boxes are commonly used in electrical systems. There are many different types of electrical boxes depending on the intended application, such as those for use with ceiling lighting and/or ceiling fans, those for use with wall switches and/or wall lighting (e.g., wall sconces, bathroom fixtures), and so on. The boxes are typically made with metal or plastic material, and are configured to receive electrical wiring and to provide a structure on which electrical components such as switches, outlets, ceiling fans, and/or lighting fixtures may be mounted and connected to the electrical wiring. The electrical boxes are typically securely fastened to wall studs, floor joists and/of ceiling joists, and the like, and may be adjusted to sit at a desired depth and allow for installation of finishing plates.

### SUMMARY

As noted above, electrical boxes are securely fastened to wall studs or floor joists during the installation process. With respect to recessed lighting fixtures, for instance, a metal can housing is typically provided, in which the electrical socket and electrical wiring resides. The can itself is secured to the wall studs or floor joists or other structure, depending on whether the lighting fixture is wall-based or ceiling-based. While such electrical connector boxes are suitable for many applications, there are a number of drawbacks. For instance, with conventional connector boxes for lighting fixtures, a user is limited to what comes with the connector box, as the fixture and connector box generally come as an operable pair. In addition, any deviation from a standard installation necessitates modifications and/or additional hardware at the time of installation, which increases costs and installation time.

Embodiments provide an electrical connector box that is able to be mounted into surfaces such as ceilings and walls and accommodates multiple types of lighting devices. The electrical connector box eases installation in that it does not need to be fixed to floor joists or other structural members. Rather, the connector box is configured with spring clips that are movable to one of multiple positions on the housing of the connector box, thereby allowing accommodation of different lighting devices. To this end, the connector box is an individual part independent of the various lighting devices with which it may be coupled. Lighting devices, along with other electrical devices, may thus be configured to seamlessly engage the connector box at installation via a variety of lock engagements. Families of lighting devices may be provided that include a particular lock engagement scheme or schemes. Embodiments are useful in new construction and in retrofit scenarios.

Numerous engagement schemes will be apparent in light of this disclosure. For example, in some embodiments, the electrical connector box is configured with a number of assembly features that are designed to twistingly engage corresponding assembly features of one or more electrical devices. In this way, the connector box may be operatively coupled with the given electrical device by simply aligning the assembly features of the connector box and the electrical device, and then twisting the connector box to lock in the interface between the two. In some embodiments, the electrical connector box is configured with three twist-based assembly features positioned one hundred and twenty degrees apart from one another to provide a robust twist-and-lock type connection. Other embodiments may include fewer or more such assembly features. In some embodiments, the connector box and electrical device assembly may be taken apart by twisting in the opposite direction.

In an embodiment, there is provided an electrical connector box. The electrical connector box includes: a housing configured with a hollow to receive electronics of a lighting device and including a first set of two or more anchor point locations and a second set of two or more anchor point locations; a first spring clip fastened to one of the first set of two or more anchor point locations such that the first spring clip is capable of moving between a compressed position and a deployed position; and a second spring clip fastened to one of the second set of two or more anchor point locations such that the second spring clip is capable of moving between a compressed position and a deployed position; wherein the anchor point locations to which the first spring clip and the second spring clip are anchored are changeable to accommodate a set of lighting devices.

In a related embodiment, the housing may be further configured with a plurality of mounting features each configured to twistingly-engage with a corresponding mounting feature of a lighting device in the set of lighting devices. In another related embodiment, the housing may be further configured with three mounting features evenly spaced on an outer sidewall of the housing, each configured to twistingly-engage with a corresponding mounting feature of a lighting device in the set of lighting devices. In yet another related embodiment, the electrical connector box may further include a first spring clip fastener and a second spring clip fastener, each configured to removably secure a corresponding one of the first spring clip and the second spring clip to one of the anchor point locations. In a further related embodiment, one of the first spring clip fastener and the second spring clip fastener may include a combination of a nut and a bolt.

In still another related embodiment, the housing may be cylindrical in shape and may be formed such that the housing and the anchor point locations are a unitary construction. In yet still another related embodiment, the housing may be further configured with one or more wire holes, each wire hole configured with a strain relief feature. In still yet another related embodiment, the first set of anchor point locations may include two anchor point locations and the second set of anchor point locations may include two anchor point locations. In yet another related embodiment, each of the first set of anchor point locations and the second set of anchor point locations may include a first flange-pair extending from an outer sidewall of the housing and having multiple opposing hole-pairs, each hole-pair to anchor a corresponding spring clip such that the spring clip is capable of moving between the compressed and deployed positions.

In another embodiment, there is provided an electrical connector box. The electrical connector box includes: a housing configured with a hollow to receive a portion of a lighting device and further configured with a plurality of mounting features configured to twistingly-engage with corresponding mounting features of the lighting device; a first spring clip; a second spring clip; a first flange-pair extending from an outer sidewall of the housing and having multiple opposing first hole-pairs, each first hole-pair configured to anchor the first spring clip such that the first spring clip is capable of moving between a compressed position and a deployed position; and a second flange-pair extending from the outer sidewall of the housing and having multiple opposing second hole-pairs, each second hole-pair configured to anchor the second spring clip such that second first spring clip is capable of moving between a compressed position and a deployed position; wherein the hole pairs in which the first spring clip and the second spring clip are anchored are changeable so as to accommodate a set of lighting devices.

In a related embodiment, the plurality of mounting features on the housing may include three mounting features evenly spaced on the outer sidewall of the housing, each configured to twistingly-engage with a corresponding mounting feature of a lighting device in the set of lighting devices. In another related embodiment, the electrical connector box may further include a first spring clip fastener and a second spring clip fastener, each configured to removably secure a corresponding one of the first spring clip and the second spring clip to a corresponding one of the first flange-pair and the second flange-pair. In still another related embodiment, the housing may be cylindrical in shape and may be formed such that the housing and the flange-pairs are a unitary construction. In yet another related embodiment, the housing may be further configured with one or more wire holes, each wire hole configured with a strain relief feature.

In another embodiment, there is provided a method of making an electrical connector box. The method includes: forming a housing having with a hollow to receive a portion of a lighting and having a first set of two or more anchor point locations and a second set of two or more anchor point locations; fastening a first spring clip to one of the first set of two or more anchor point locations such that the first spring clip is capable of moving between a compressed position and a deployed position; and fastening a second spring clip to one of the second set of two or more anchor point locations such that the second spring clip is capable of moving between a compressed position and a deployed position; wherein the anchor point locations to which the first spring clip and the second spring clip are anchored are changeable to accommodate a set of lighting devices.

In a related embodiment, forming the housing may further include forming a plurality of mounting features on an outer sidewall of the housing, wherein each mounting feature is capable of twistingly-engaging with a corresponding mounting feature of the lighting device; and configuring one or more wire holes, each wire hole having a strain relief feature.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIGS. 1A-1B illustrate a mountable electrical connector box according to embodiments disclosed herein.

FIGS. 2A-2B illustrate how the mountable electrical connector box of FIGS. 1A-1B may be interfaced with a lighting device, according to embodiments disclosed herein.

FIG. 3 and FIGS. 4A-4B illustrate how the mountable electrical connector box and interfaced lighting device of FIGS. 2A-2B may be installed to provide ceiling-based lighting, according to embodiments disclosed herein.

FIGS. 5A-5B illustrate how the mountable electrical connector box of FIGS. 1A-1B may be interfaced with another lighting device, according to embodiments disclosed herein.

FIG. 6 and FIGS. 7A-7B illustrate how the mountable electrical connector box and interfaced another lighting device of FIGS. 5A-5B may be installed to provide ceiling-based lighting, according to embodiments disclosed herein.

FIGS. 8A-8C illustrate how an assembly of a mountable connector box and the another lighting device may be installed in a recessed lighting can so as to provide ceiling-based lighting, according to embodiments disclosed herein.

### DETAILED DESCRIPTION

Embodiments provide an electrical connector box that may be mounted into various surfaces, such as but not limited to ceilings and walls, and accommodates multiple types of electric devices. Though embodiments are described with respect to one or more lighting devices, which include any type of light source, embodiments are not so limited and these descriptions are merely for ease of convenience. The electrical connector box may be, and in some embodiments is, made from any suitable materials and/or using any appropriate manufacturing process. In some embodiments, the electrical connector box is formed from molded plastic, so as to provide a one-piece construction to which spring clips and/or other mounting devices may be removably fastened. The plastic may be, for example, and in some embodiments is, PVC (polyvinyl chloride), phenolic resin, fiberglass, or the like. Other materials, such as but not limited to metal and wood, may be used if desired. However, moldable plastic provides a number of manufacturing advantages, as will be appreciated.

Though embodiments described herein focus on ceiling-based applications, this is for ease of explanation only. Numerous other applications will be apparent in light of this disclosure, and embodiments may be and in some applications are used for mounting in other surfaces and for other electrical devices. For example, embodiments may also be used for wall-based lighting applications, such as but not limited to sconces, porch lights, hallway lighting, bathroom lighting, and so on. Likewise, electrical devices such as but not limited to temporary switching, electrical control panel applications (e.g., temperature, dimming, etc), and the like may also use one or more electrical connector boxes according to embodiments described herein.

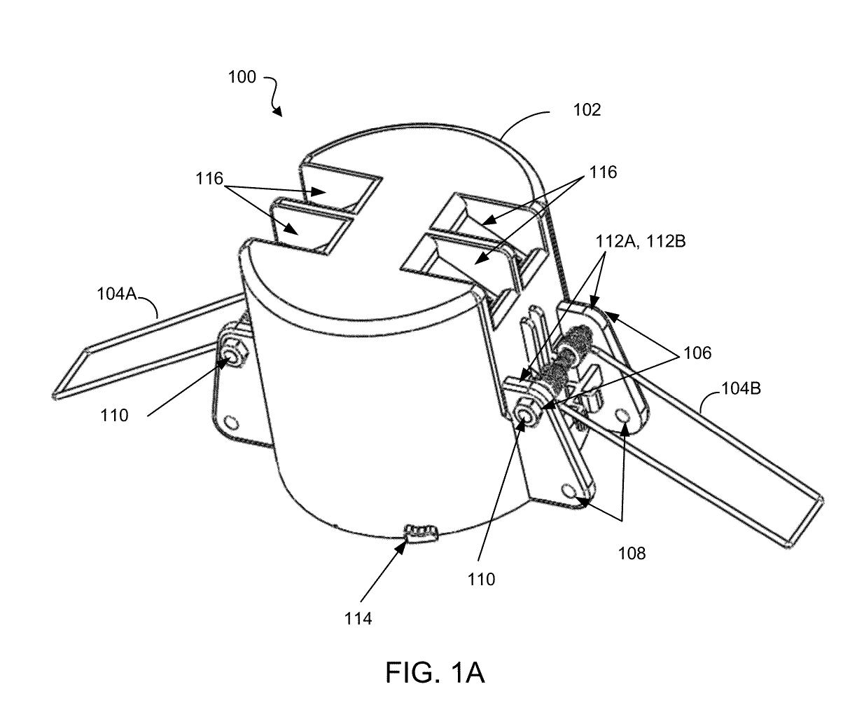

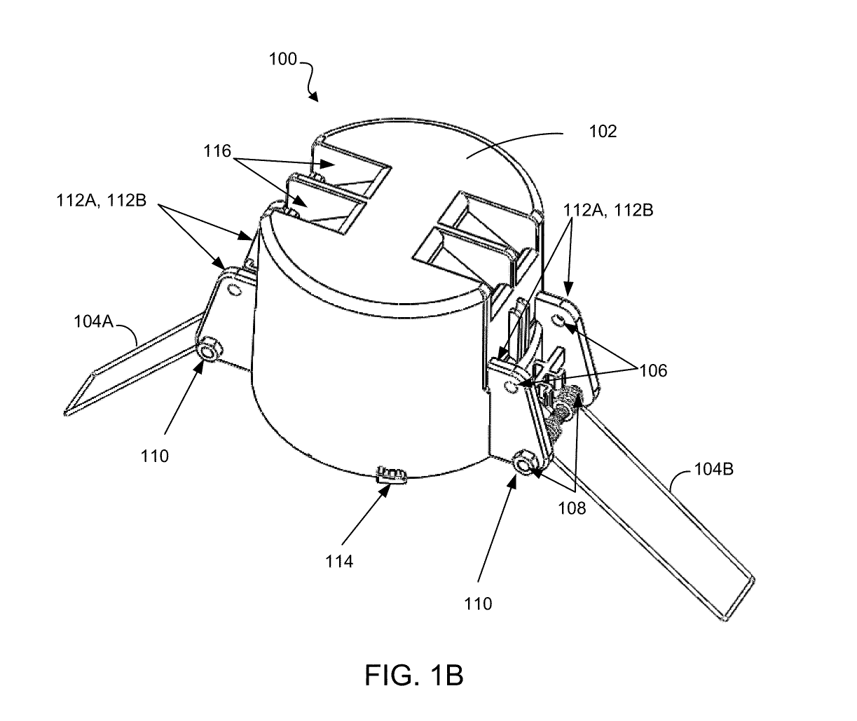

FIGS. 1A-1B illustrate an electrical connector box 100 capable for mounting electrical devices on surfaces. As shown, the electrical connector box 100 includes a housing 102 upon which two spring clips 104A, 104B are operatively coupled. The housing 102 may be, for example, and in some embodiments is, injection molded plastic. In some embodiments, the housing 102 is a single unitary piece having features such as those shown in FIGS. 1A and 1B. As shown in FIGS. 1A and 1B, the housing 102 is substantially cylindrical in shape and includes a center that is hollow, so as to provide a void within which circuitry and/or a portion of a lighting device, such as but not limited to a luminaire, may be positioned. Of course, the housing 102 of the electrical connector box 100 is able to take on any shape and/or substantially any shape, including combinations of shapes (for example but not limited to a substantially cylindrical portion closed at one end and open at the opposite end, attached at the opposite end to a substantially rectangular portion). The spring clips 104A, 104B are removably fastened to the housing 102. As shown in FIGS. 1A and 1B, the spring clips 104A, 104B are removably fastened at one of two sets of anchor points 106, 108. FIG. 1A shows the spring clips 104A, 104B removable fastened to an upper anchor point 106, and FIG. 1B shows the spring clips 104A, 104B removably fastened to a lower anchor point 108. In some embodiments, a spring clip fastener 110 is used to secure the spring clips 104A, 104B to the desired location on the housing 102 (e.g., one or more anchor points 106, 108). The spring clip fastener 110 may be, and in some embodiments is, implemented via any suitable fasteners that are able to be secured and unsecured to the housing 102 as desired while allowing the spring clips 104A, 104B to function, for example but not limited to via a nut and bolt combination, a pin and corresponding receiving socket, and so on. The desired locations on the housing 102 to which the spring clips 104A, 104B may be fastened, whether anchor points 106, 108 or some other point and/or points, are configured to receive the spring clip fastener 110 in such a way as to provide sufficient rigidity and robustness to accommodate multiple changes in the location of the spring clip(s) 104A, 104B. The desired locations are also configured to otherwise securely maintain a spring clip 104A, 104B in place once the spring clip fastener 110 has been tightened or otherwise deployed.

In FIGS. 1A and 1B, the anchor points 106, 108 associated with a given spring clip 104A, 104B are implemented with two flange-like extensions 112A, 112B configured on the side of the housing 102 and sufficiently spaced from one another in an opposing fashion so that the spring clip 104A, 104B fits therebetween. A set of two flange-like extensions 112A, 112B is generally referred to throughout as a flange-pair 112A, 112B. Each flange-like extension 112A, 112B in the flange-pair 112A, 112B has a set of holes, with each hole of one flange-like extension 112A, 112B corresponding to a hole of the opposing flange-like extension 112A, 112B, so as to allow a bolt or other suitable fastening mechanism to be threaded or otherwise placed through corresponding holes in each flange-like extension 112A, 112B. Such a pair of corresponding holes is generally referred to throughout as a hole-pair. The bolt or other suitable fastening mechanism is also threaded or otherwise placed through the spring tube of the intervening spring clip 104A, 104B or other suitable mechanism. In FIGS. 1A and 1B, each flange-like extension 112A, 112B is shown as having two holes, but of course fewer or more holes may be and in some embodiments are used. A larger number of holes in a set of holes may be used to provide a greater degree of flexibility and/or to accommodate more types of electrical devices, including luminaires, with which the electrical connector box 100 may be, and in some embodiments is, coupled.

The housing 102 is also configured with a plurality of mounting features 114 configured to engage with a corresponding mounting feature of a given luminaire or other electrical device (not shown in FIGS. 1A and 1B, but shown in other drawings). As previously explained, the housing 102 may be, and in some embodiments is, made from any suitable material or materials, such as but not limited to PVC, phenolic resin, fiberglass, metal, including combinations thereof. As will be explained, the mounting features 114 may be, and in some embodiments are, configured to provide a twist-and-lock mechanism, thereby allowing for a relatively easy assembly process. One or more punch-out features or holes 116, or the like, are provided in the top of the electrical connector box 100 to allow for passage of wiring so that power may be provided to the electrical device to which the electrical connector box 110 is connected. Such punch-out features and/or holes 116 and/or the like may be configured so as to provide a degree of strain relief for any wiring travelling there through. In some embodiments, the housing 102 of the electrical connector box 100 and/or features 114 thereon are made using injection molding techniques. Alternatively, in other embodiments, pressing and/or milling techniques are used. Of course, any suitable forming techniques for the electrical connector box 100 are also contemplated.

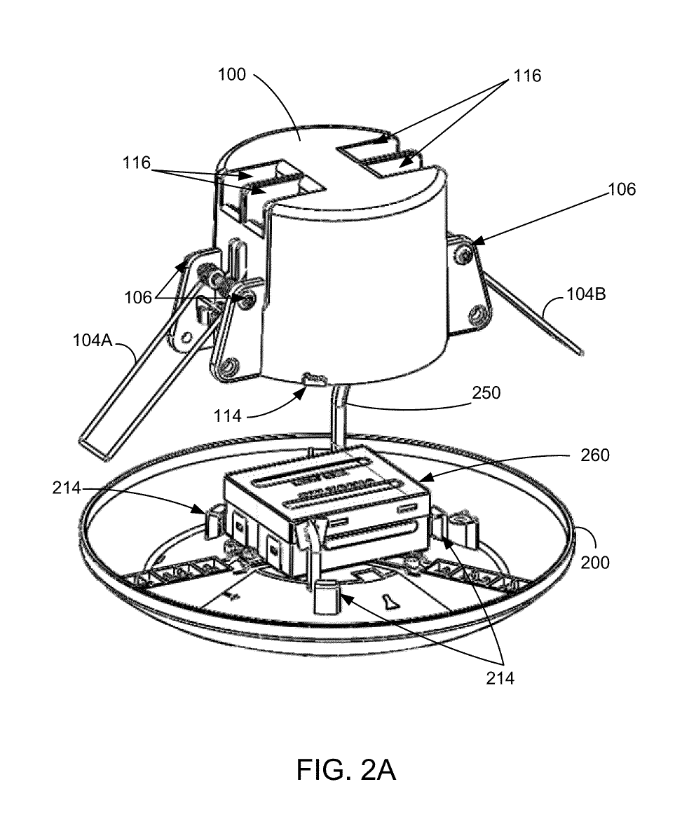

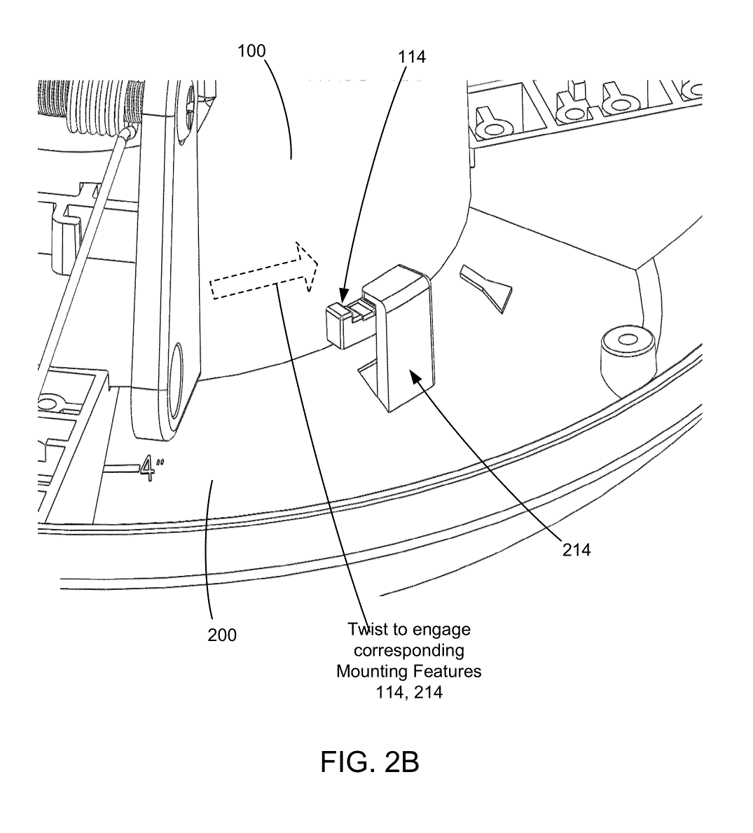

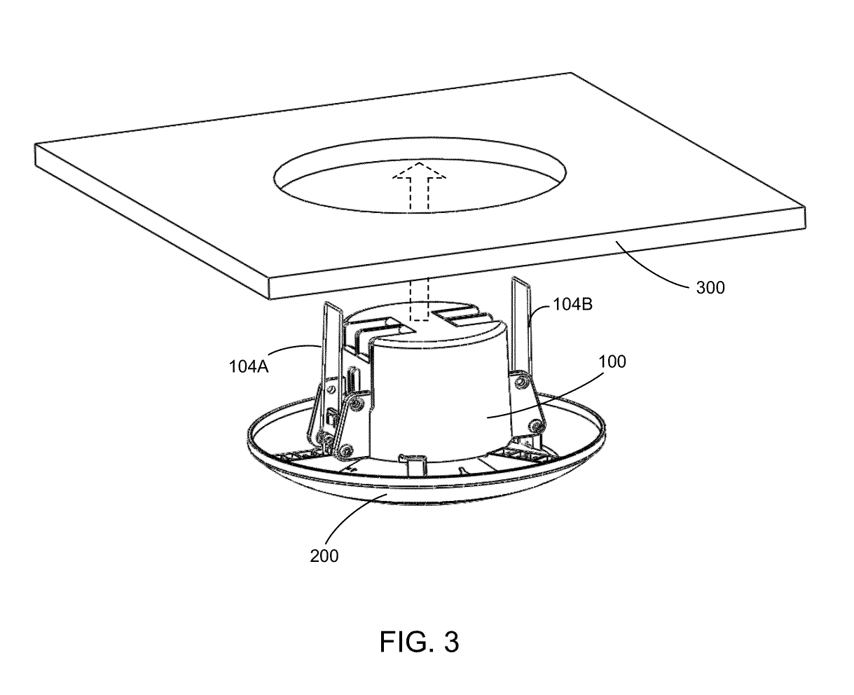

FIGS. 2A-2B illustrate how the electrical connector box 100 of FIGS. 1A and 1B interface with a lighting device 200, which is shown in FIGS. 2A, 2B, and 3, among others. In FIG. 2A, the spring clips 104A, 104B are mounted in the upper anchor points 106, and the electrical connector box 100 is coupled with the lighting device 200, which is a disk-shaped luminaire, such as but not limited to an ULTRA LED Light Disk downlight luminaire available from OSRAM SYLVANIA. However, and as will be appreciated in light of this disclosure, the lighting device 200 may be and in some embodiments is any type of lighting device having a configuration that allows the lighting device to securely engage with the electrical connector box 100 as variously described herein. For instance, as shown in FIG. 2A, the lighting device 200 includes three mounting features 214 disposed about one hundred and twenty degrees apart from one another, so as to rotatingly engage and lock with a corresponding mounting feature 114 disposed on a side of the housing 102 of the electrical connector box 100. FIG. 2B shows the electrical connector box 100 coupled to the lighting device 200, with further details of the mounting features 114, 214 according to some embodiments. As is seen in FIG. 2B, the hollow of the electrical connector box 100 is sufficiently sized to receive and cover a portion of the lighting device 200 including, for example, electronics 260 associated with the lighting device 200, when the corresponding mounting features 114, 214 are engaged with each other. In some embodiments, electrical wiring 250 to the lighting device 200 pass through one or more of the top punch-outs or holes 116 in the electrical connector box 100, and are connected to the lighting device 200.

In some embodiments, the electrical connector box 100 is coupled to the lighting device 200 using the following procedure. First, wires from the mainline power source are routed through one or more features 116 on top of the electrical connector box 100. These wires are connected to one or more wires of the lighting device 200 in any conventional method. Once the necessary wiring connections are made, the electrical connector box 100 is brought closer to the lighting device 200, such that the mounting features 114 of the electrical connector box 100 are aligned with the corresponding mounting features 214 of the lighting device 200, and then twisting one or the other in a direction (e.g., counter-clockwise) to attach the electrical connector box 100 to the lighting device 200, as shown in FIG. 2B. While FIG. 2B shows three mounting features 114, 214 evenly spaced on each of the electrical connector box 100 and luminaire 200, some embodiments are configured with fewer or more such mounting features 114, 214, depending on factors such as but not limited to the desired robustness of the interface between the electrical connector box 100 and the lighting device 200 balanced against the desired ease of the alignment and twisting action. The twist and lock type mounting feature allows for quick and reliable attachment of the electrical connector box 100 to the lighting device 200. In some embodiments, the twist and lock type mounting feature 114, 214 is further configured to allow for detachment of the electrical connector box 100 and the lighting device 200 by a similar twisting action in the opposite direction.

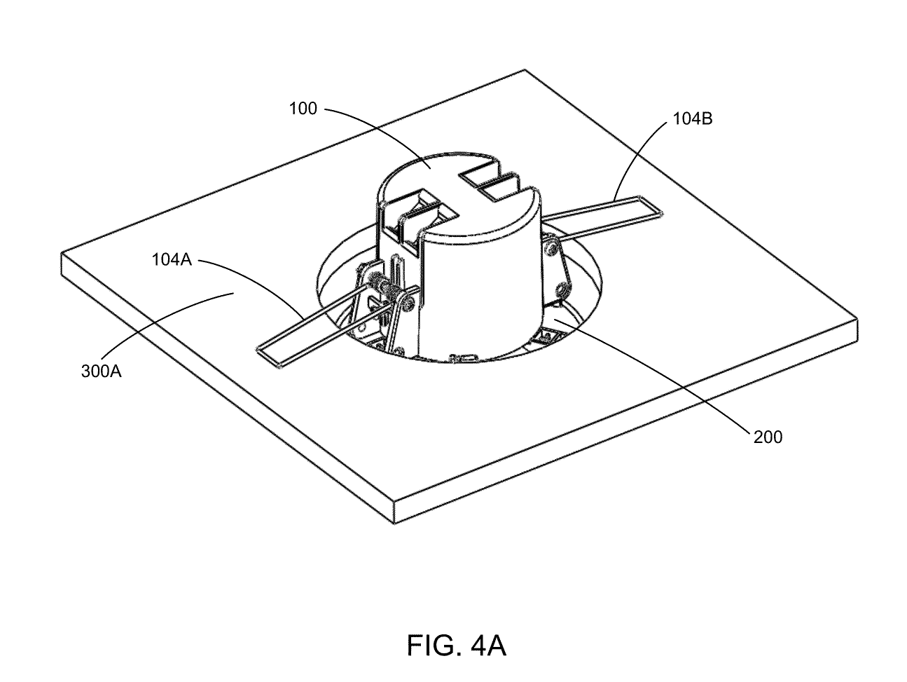

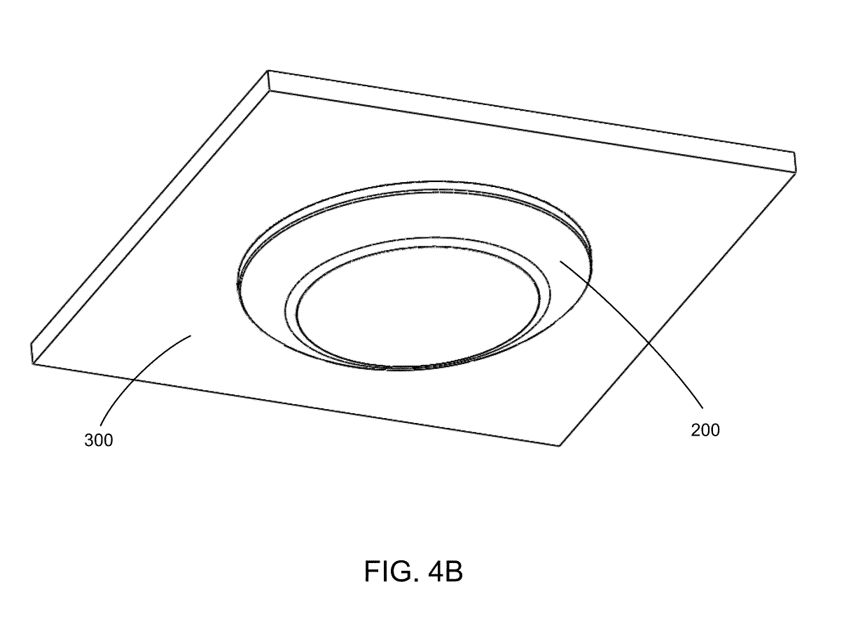

FIG. 3 illustrates how the electrical connector box 100 and the lighting device 200, when coupled as shown in FIG. 2B, is able to be installed into a surface 300, such as but not limited to a ceiling tile 300, though of course any surface capable of receiving the coupled electrical connector box 100 and the lighting device 200 is usable. As seen, with the lighting device 200 coupled to the electrical connector box 100, creating a lighting assembly, the spring clips 104A, 104B of the electrical connector box 100 may be compressed inwards towards the electrical connector box 100. This position for the spring clips 104A, 104B is referred to throughout as a compressed position. The lighting assembly is then aligned with an appropriate sized opening, hole, or the like in the ceiling tile 300, and pushed inside. The spring clips 104A, 104B are then released to their deployed position, after the lighting assembly is inside the hole, as shown in FIG. 4A. In the deployed position, the spring clips 104A, 104B effectively sit or are otherwise in at least partial contact against a surface 300A opposite the surface 300 the exterior-facing portion of the lighting device 200 is in contact with. The spring clips 104A, 104B in their deployed position securely hold the lighting assembly in place. FIG. 4B shows the surface 300 that the exterior-facing portion of the lighting device 200 is in contact with, as well as the exterior-facing portion of the lighting device 200.

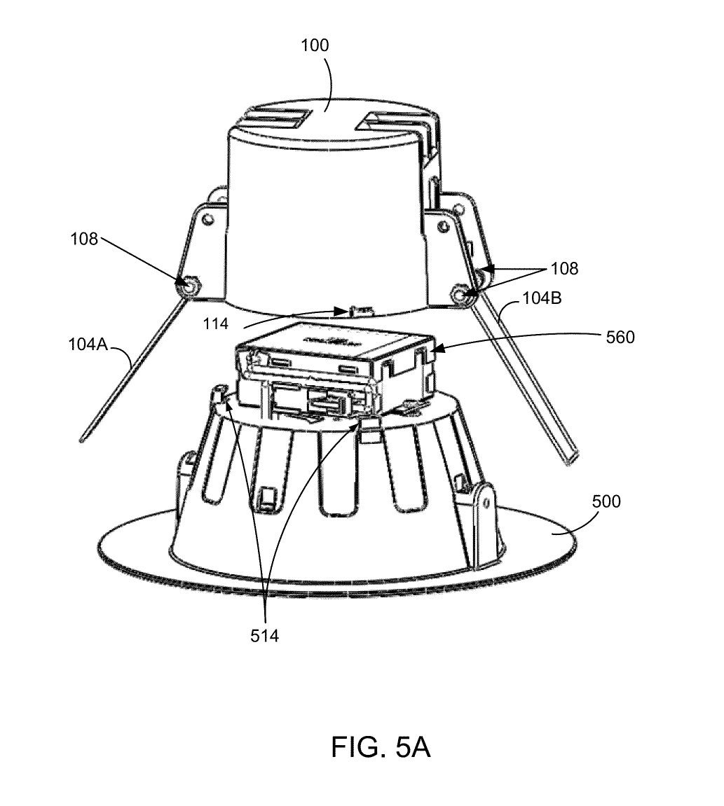

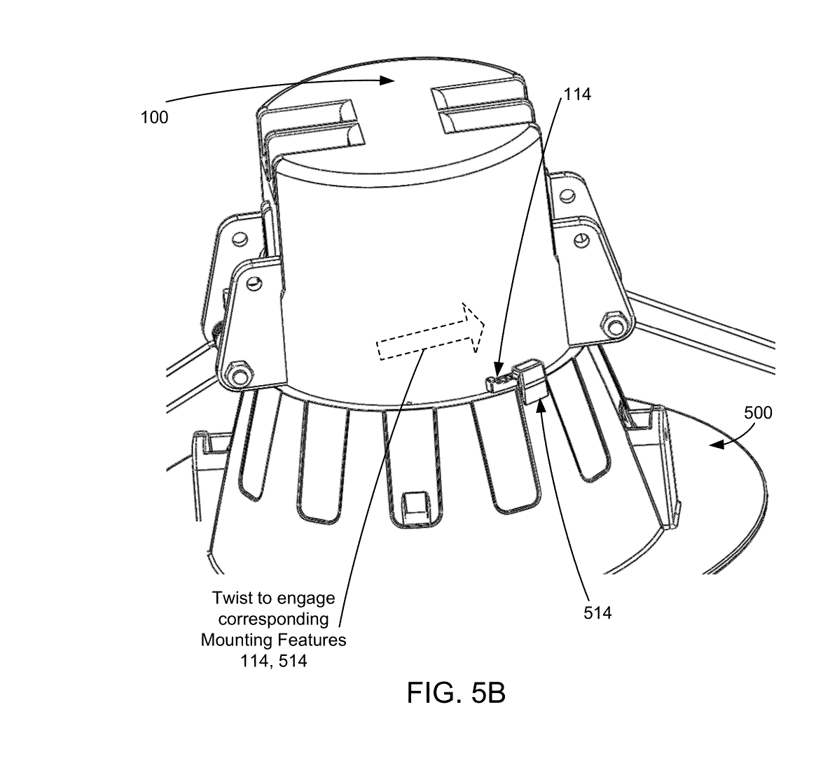

FIGS. 5A and 5B illustrate the electrical connector box 100 of FIGS. 1A-1B interfacing with another lighting device 500, such as but not limited to an ULTRA RT6 LED recessed luminaire or an ULTRA RT6 Gimbal LED recessed luminaire, both available from OSRAM SYLVANIA. The another lighting device 500 shown has a hat-like shape, however, the another lighting device 500 may be, and in some embodiments is, any lighting device having a configuration that allows the lighting device to securely engage with the electrical connector box 100 as variously described herein. In FIGS. 5A and 5B, the spring clips 104A, 104B of the electrical connector box 100 are mounted in a set of lower anchor points 108, so as to properly secure the another lighting device 500. The another lighting device 500 includes three mounting features 514 disposed about one hundred and twenty degrees apart from one another and on a surface of the another lighting device 500. These three mounting features 514, similar to the mounting features 214 on the lighting device 200 shown in FIGS. 2A-2B, rotatingly engage and lock with corresponding mounting features 114 disposed on a side of the housing 102 of the electrical connector box 100. FIG. 5B shows the electrical connector box 100 coupled to the another lighting device 500. The hollow of the electrical connector box 100 is sufficiently sized so as to receive and cover at least a portion of the another lighting device 500, particularly a portion including electronics 560 associated with the another lighting device 500, when the corresponding mounting features 114, 514 are engaged. In some embodiments, the electrical wiring (not shown in FIGS. 5A and 5B) to the another lighting device 500 passes through one or more of the openings 116 in the electrical connector box 100 and is connected to the another lighting device 500, with the wiring connection(s) located within the electrical connector box 100.

In some embodiments, the electrical connector box 100 is coupled to the another lighting device 500 similar to the coupling of the electrical connector box 100 to the lighting device 200, described above in connection with FIGS. 2A and 2B. More specifically, after wiring from the input power source is routed into the electrical connector box 100, this wiring is connected to wires of the another lighting device 500 using any known mechanisms and/or methods. The electrical connector box 100 is then brought closer to the another lighting device 500, such that the mounting features 114 of the electrical connector box 100 are aligned with the corresponding mounting features 514 of the another lighting device 500. One of the electrical connector box 100 and the another lighting device 500 are twisted with respect to the other, attaching the electrical connector box 100 to the another lighting device 500. Though FIG. 5B shows three mounting features 114, 514 evenly spaced on each of the electrical connector box 100 and the another lighting device 500, in some embodiments, fewer or more such mounting features are present, depending on factors such as the desired robustness of the interface therebetween balanced against the desired ease of the alignment and twisting action. The twist and lock type mounting feature 114, 514 allows for quick and reliable attachment of electrical connector box 100 to the another lighting device 500. In some embodiments, the twist and lock type mounting features 114, 514 are further configured to allow for detachment by a similar twisting action in the opposite direction.

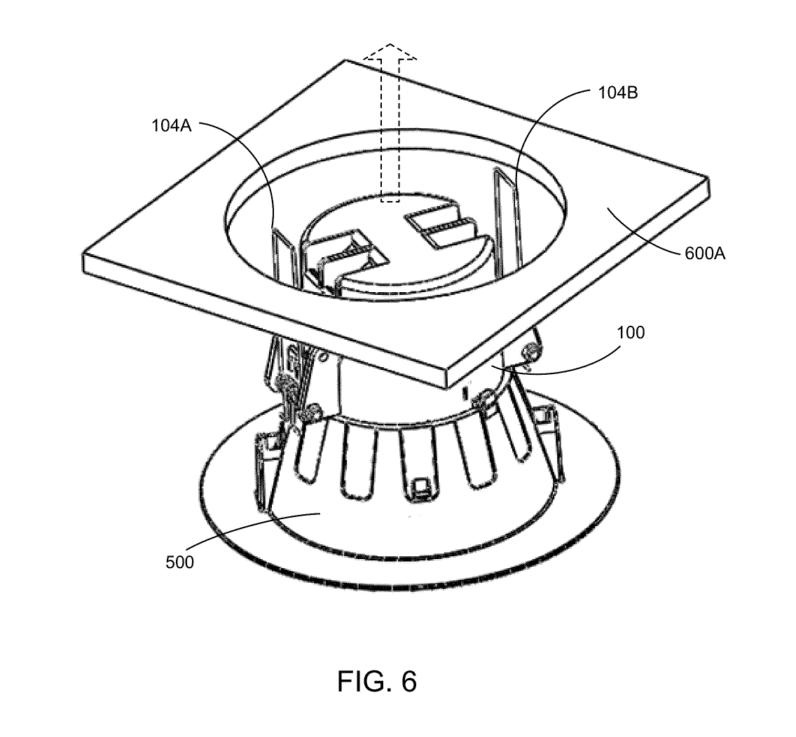

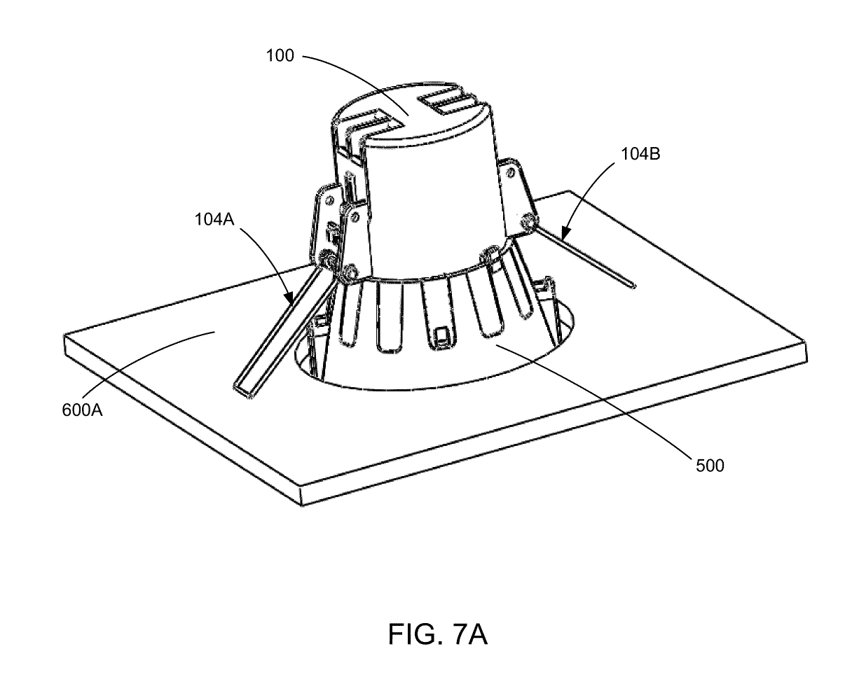

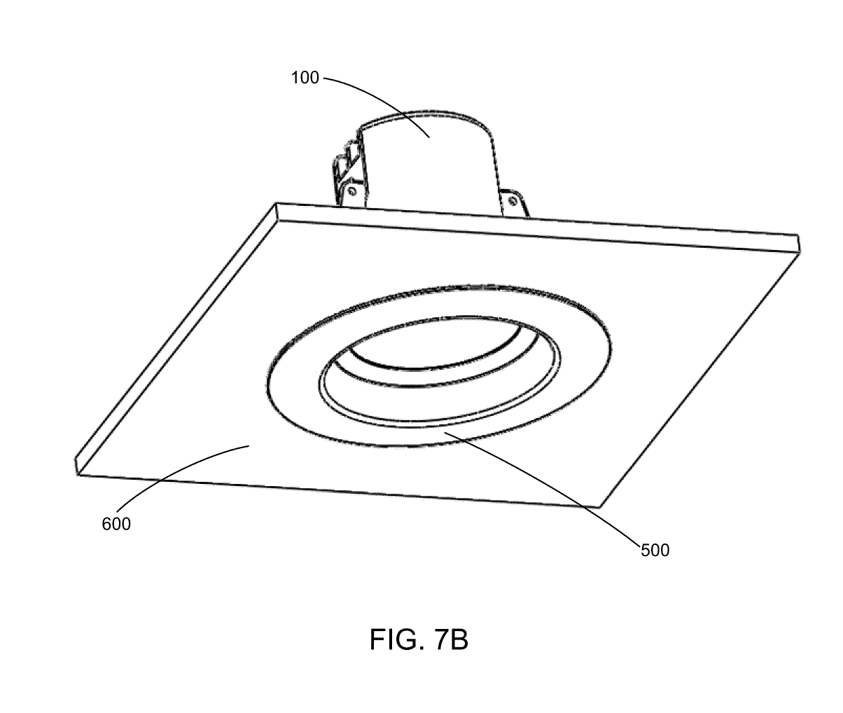

FIG. 6 illustrates the installation of the coupled together electrical connector box 100 and the another lighting device 500 of FIGS. 5A-5B into a surface 600A, such as but not limited to a ceiling tile 600A. As shown in FIG. 6, with the another lighting device 500 coupled to the electrical connector box 100, creating a lighting assembly, the spring clips 104A, 104B of the electrical connector box 100 may be compressed inwards towards the electrical connector box 100. This position for the spring clips 104A, 104B is the compressed position discussed above with regards to FIGS. 4A and 4B. The lighting assembly is then aligned with an appropriate sized opening, hole, or the like in the ceiling tile 600A, and pushed inside. The spring clips 104A, 104B are then released to their deployed position, after the lighting assembly is inside the hole, as shown in FIG. 7A. By locating the spring clips 104A, 104B in the lower anchor points 108, the additional height of the another lighting device 500 (compared to the lighting device 200) is offset, so that the spring clips 104A, 104B in their deployed position effectively sit or are otherwise in at least partial contact against the surface 600A opposite a surface 600 the exterior-facing portion of the another lighting device 500 is in contact with, as shown in FIG. 7B. The spring clips 104A, 104B in their deployed position securely hold the lighting assembly in place. FIG. 7B shows the surface 600 that the exterior-facing portion of the another lighting device 500 is in contact with, as well as the exterior-facing portion of the another lighting device 500.

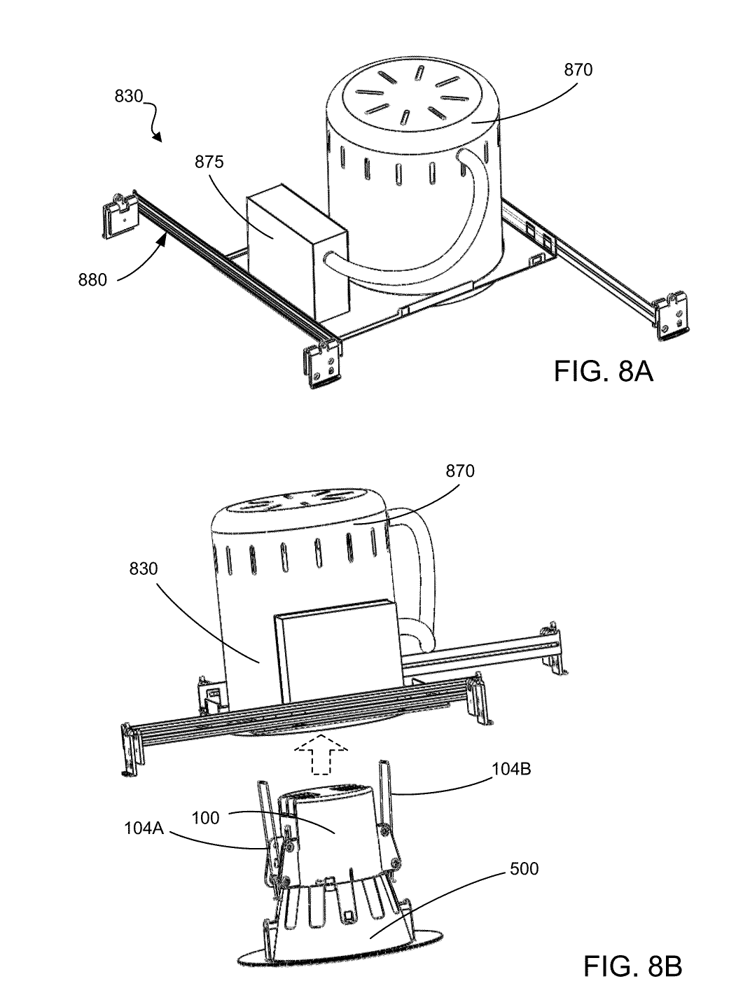

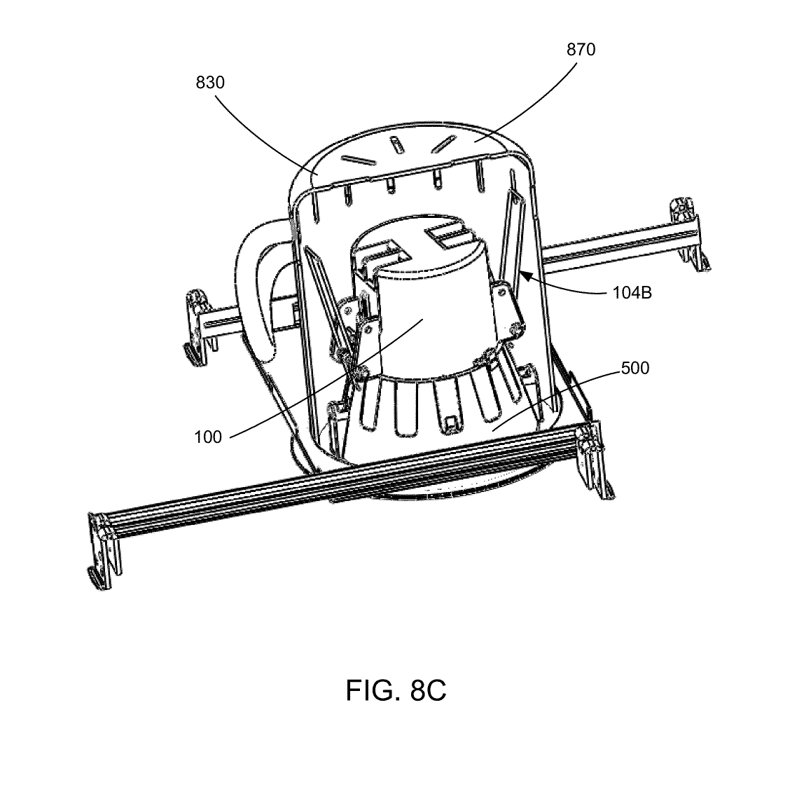

FIGS. 8A, 8B, and 8C illustrate the installation of an electrical connector box 100 coupled to a lighting device, so as to form a lighting assembly, within a given recessed lighting fixture 830. As will be appreciated, the recessed lighting fixture 830 need not be specifically designed to operate with the electrical connector box 100, the lighting device 800, or the combination as a lighting assembly. Rather, the electrical connector box 100 provides flexibility of installation, effectively allowing a lighting assembly including the electrical connector box 100 to be used with a variety of recessed lighting fixtures. As shown in FIG. 8A, the recessed lighting fixture 830 is implemented as typically known in the art, and thus generally includes a fixture can 870, electronics 875, and installation bracing 880. The installation bracing 880 is used to secure the recessed lighting fixture 830 to, for example, floor joists or other structural members (not shown). The electronics 875 are connected to a power source that provides mainline power, and are configured to process that mainline power to a suitable voltage so as to power a lighting device installed in the recessed lighting fixture 830. Numerous such can-based fixtures are known in the art, and embodiments of the electrical connector box 100 disclosed throughout are usable with any such fixture.

FIG. 8B shows the electrical connector box 100 coupled to the another lighting device 500, so as to form a lighting assembly. The lighting assembly is inserted into the can 870 of the recessed lighting fixture 830. As is shown, during this insertion, the spring clips 104A, 104B of the electrical connector box 100 are in their compressed position. The entire lighting assembly is then aligned with and pushed into the can 870. The spring clips 104A, 104B are then released to their deployed position, once the lighting assembly is inside the can 870, as shown in FIG. 8C. In their deployed position, the spring clips 104A, 104B press, engage with, or are otherwise in contact with walls and/or mounting features of the can 870, securely holding the lighting assembly in place. Though FIGS. 8B and 8C shown a lighting assembly including the another lighting device 500, other types of lighting devices, such as but not limited to the lighting device 200 shown in FIGS. 2A-4B, may be and in some embodiments are used. In a more general sense, any number of combinations of electrical connector box 100 with a lighting device may be and are deployed within a can of a given recessed lighting fixture.

In some embodiments, the interior wall or walls of a can of a recessed lighting fixture may include particular bracketing or other connectors configured to receive a particular lighting assembly, specifically designed for use with that recessed lighting fixture. A lighting assembly including a lighting device and an electrical connector box according to embodiments disclosed throughout will either work with (i.e., use) or work around (i.e., not use) such particular bracketing or other connectors. In some embodiments, electrical wiring to the recessed lighting fixture may be rewired or otherwise operatively connected to the electrical connector box of a lighting assembly within the recessed lighting fixture, so as to power the lighting device that is part of the lighting assembly. In some embodiments, an intermediate wire from the electronics and/or other portion of the recessed lighting fixture to the lighting assembly is provided. In some such embodiments, the electrical connector box and/or lighting device is further configured with one or more wiring connectors to facilitate this intermediate connection. The wiring connectors may include, for example, but are not limited to, any type of standardized and/or custom plug-and-clip connectors that allow an intermediate connection from between the a portion of the lighting assembly and a portion of the recessed lighting fixture. In such embodiments, power may be routed to the lighting device for lighting a given area.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. An electrical connector box, comprising:
a housing configured with a hollow to receive electronics of a lighting device and including a first set of two or more anchor point locations and a second set of two or more anchor point locations;
a first spring clip fastened to one of the first set of two or more anchor point locations such that the first spring clip is capable of moving between a compressed position and a deployed position; and
a second spring clip fastened to one of the second set of two or more anchor point locations such that the second spring clip is capable of moving between a compressed position and a deployed position;
wherein the anchor point locations to which the first spring clip and the second spring clip are anchored are changeable to accommodate a set of lighting devices.

2. The electrical connector box of claim 1, wherein the housing is further configured with a plurality of mounting features each configured to twistingly-engage with a corresponding mounting feature of a lighting device in the set of lighting devices.

3. The electrical connector box of claim 1, wherein the housing is further configured with three mounting features evenly spaced on an outer sidewall of the housing, each configured to twistingly-engage with a corresponding mounting feature of a lighting device in the set of lighting devices.

4. The electrical connector box of claim 1, further comprising a first spring clip fastener and a second spring clip fastener, each configured to removably secure a corresponding one of the first spring clip and the second spring clip to one of the anchor point locations.

5. The electrical connector box of claim 4, wherein one of the first spring clip fastener and the second spring clip fastener comprises a combination of a nut and a bolt.

6. The electrical connector box of claim 1, wherein the housing is cylindrical in shape and is formed such that the housing and the anchor point locations are a unitary construction.

7. The electrical connector box of claim 1, wherein the housing is further configured with one or more wire holes, each wire hole configured with a strain relief feature.

8. The electrical connector box of claim 1, wherein the first set of anchor point locations includes two anchor point locations and the second set of anchor point locations includes two anchor point locations.

9. The electrical connector box of claim 1, wherein each of the first set of anchor point locations and the second set of anchor point locations includes a first flange-pair extending from an outer sidewall of the housing and having multiple opposing hole-pairs, each hole-pair to anchor a corresponding spring clip such that the spring clip is capable of moving between the compressed and deployed positions.

10. An electrical connector box, comprising:
a housing configured with a hollow to receive a portion of a lighting device and further configured with a plurality of mounting features configured to twistingly-engage with corresponding mounting features of the lighting device;
a first spring clip;
a second spring clip;
a first flange-pair extending from an outer sidewall of the housing and having multiple opposing first hole-pairs, each first hole-pair configured to anchor the first spring clip such that the first spring clip is capable of moving between a compressed position and a deployed position; and
a second flange-pair extending from the outer sidewall of the housing and having multiple opposing second hole-pairs, each second hole-pair configured to anchor the second spring clip such that second first spring clip is capable of moving between a compressed position and a deployed position;
wherein the hole pairs in which the first spring clip and the second spring clip are anchored are changeable so as to accommodate a set of lighting devices.

11. The electrical connector box of claim 10, wherein the plurality of mounting features on the housing comprises three mounting features evenly spaced on the outer sidewall of the housing, each configured to twistingly-engage with a corresponding mounting feature of a lighting device in the set of lighting devices.

12. The electrical connector box of claim 10, further comprising a first spring clip fastener and a second spring clip fastener, each configured to removably secure a corresponding one of the first spring clip and the second spring clip to a corresponding one of the first flange-pair and the second flange-pair.

13. The electrical connector box of claim 10, wherein the housing is cylindrical in shape and is formed such that the housing and the flange-pairs are a unitary construction.

14. The electrical connector box of claim 10, wherein the housing is further configured with one or more wire holes, each wire hole configured with a strain relief feature.

15. A method of making an electrical connector box, comprising:
forming a housing having with a hollow to receive a portion of a lighting and having a first set of two or more anchor point locations and a second set of two or more anchor point locations;
fastening a first spring clip to one of the first set of two or more anchor point locations such that the first spring clip is capable of moving between a compressed position and a deployed position; and
fastening a second spring clip to one of the second set of two or more anchor point locations such that the second spring clip is capable of moving between a compressed position and a deployed position;
wherein the anchor point locations to which the first spring clip and the second spring clip are anchored are changeable to accommodate a set of lighting devices.

16. The method of claim 15, wherein forming the housing further comprises:
forming a plurality of mounting features on an outer sidewall of the housing, wherein each mounting feature is capable of twistingly-engaging with a corresponding mounting feature of the lighting device; and
configuring one or more wire holes, each wire hole having a strain relief feature.
